(19) United States
(12) Patent Application Publication
(10) Pub. No.: US 2021/0248553 A1
(43) Pub. Date: Aug. 12, 2021

(54) METHOD AND APPARATUS FOR DELIVERING ARTICLE

(71) Applicants: Beijing Jingdong Shangke Information Technology Co., Ltd., Beijing (CN); Beijing Jingdong Century Trading Co., Ltd., Beijing (CN)

(72) Inventor: Qi Zhang, Beijing (CN)

(73) Assignees: Beijing Jingdong Shangke Information Technology Co., Ltd., Beijing (CN); Beijing Jingdong Century Trading Co., Ltd., Beijing (CN)

(21) Appl. No.: 17/241,758

(22) Filed: Apr. 27, 2021

Related U.S. Application Data
(63) Continuation of application No. PCT/CN2019/129093, filed on Dec. 27, 2019.

(30) Foreign Application Priority Data
Mar. 25, 2019 (CN) 201910226651.5

(51) Int. Cl. G06Q 10/08; G07C 9/20; H04W 4/029; H04N 7/18

(52) U.S. Cl. CPC G06Q 10/0838; G07C 9/20; H04N 7/188; H04N 7/185; H04W 4/029

(57) ABSTRACT

A method and apparatus for delivering an article are provided. The method may include: in response to reception of a vehicle unlocked notification message sent by a terminal device of a user, sending the vehicle unlocked notification message to a terminal device of a deliveryman; in response to reception of an article delivered notification message sent by the terminal device of the deliveryman, sending the article delivered notification message to the terminal device of the user; in response to reception of a vehicle locked notification message sent by the terminal device of the user, sending the vehicle locked notification message to the terminal device of the deliveryman.

### CROSS-REFERENCE TO RELATED APPLICATIONS

This application is a continuation of International Application No. PCT/CN2019/129093, filed on Dec. 27, 2019, which claims priority to Chinese Patent Application No. 201910226651.5, filed on Mar. 25, 2019, and entitled “Method and Apparatus for Delivering Article,” the contents of which are incorporated herein by reference in their entireties.

### TECHNICAL FIELD

Embodiments of the present disclosure relate to the field of logistics technology, and specifically to a method and apparatus for delivering an article.

### BACKGROUND OF THE INVENTION

Logistics delivery, that is, an article circulation method from the perspective of the business mode of article circulation, is a modern article circulation method. The logistics delivery is a logistics method positioned to provide services for e-commerce customers, implement unified information management and scheduling for an entire logistics delivery system based on the characteristics of e-commerce, tally goods in a logistics base and deliver matched articles to users according to user order requirements.

At present, in the process of logistics delivery, when a deliveryman arrives at the community where a user lives, the deliveryman may first contact the user by phone. If the user is at home, the deliveryman generally delivers the article home. If the user is not at home, the deliveryman generally delivers the article to a collection point or express cabinet in the community. When the user returns home, the article may be picked up from the collection point or express cabinet.

### SUMMARY OF THE INVENTION

Embodiments of the present disclosure propose a method and apparatus for delivering an article.

In a first aspect, embodiments of the present disclosure provide a method for delivering an article, the method including: sending a vehicle unlocked notification message to a terminal device of a deliveryman, in response to reception of the vehicle unlocked notification message sent by a terminal device of a user; sending an article delivered notification message to the terminal device of the user, in response to reception of the article delivered notification message sent by the terminal device of the deliveryman, the article being delivered to the vehicle; and sending a vehicle locked notification message to the terminal device of the deliveryman, in response to reception of the vehicle locked notification message sent by the terminal device of the user.

In some embodiments, before the sending the vehicle unlocked notification message to the terminal device of the deliveryman, in response to reception of the vehicle unlocked notification message sent by the terminal device of the user, the method further comprises: sending a vehicle location arrived notification message to the terminal device of the user, in response to reception of the vehicle location arrived notification message sent by the terminal device of the deliveryman.

In some embodiments, before the sending the vehicle unlocked notification message to the terminal device of the deliveryman, in response to reception of the vehicle unlocked notification message sent by the terminal device of the user, the method further comprises: receiving location information of a current location of the deliveryman sent by the terminal device of the deliveryman; matching the location information of the current location of the deliveryman with location information of a location of the vehicle; and sending a vehicle location arrived notification message to the terminal device of the user, in response to matching successfully.

In some embodiments, the method further comprises: sending a delivery video recording unlocking instruction for the article to a camera device of the deliveryman, in response to reception of the vehicle unlocked notification message sent by the terminal device of the user; and sending a delivery video recording stop instruction for the article to the camera device of the deliveryman, in response to reception of the vehicle locked notification message sent by the terminal device of the user.

In some embodiments, after the sending the delivery video recording stop instruction for the article to the camera device of the deliveryman, the method further comprises: acquiring a delivery video of the article from the camera device of the deliveryman, and storing the delivery video of the article.

In some embodiments, after the acquiring the delivery video of the article from the camera device of the deliveryman, and storing the delivery video of the article, the method further comprises: sending a delivery video viewing notification message of the article to the terminal device of the user; and sending the delivery video of the article to the terminal device of the user, in response to reception of a delivery video viewing confirmation message of the article sent by the terminal device of the user.

In a second aspect, embodiments of the present disclosure provide an apparatus for delivering an article, the apparatus including: a first sending unit, configured to send a vehicle unlocked notification message to a terminal device of a deliveryman, in response to reception of the vehicle unlocked notification message sent by a terminal device of a user; a second sending unit, configured to send an article delivered notification message to the terminal device of the user, in response to reception of the article delivered notification message sent by the terminal device of the deliveryman, the article being delivered to the vehicle; and a third sending unit, configured to send a vehicle locked notification message to the terminal device of the deliveryman, in response to reception of the vehicle locked notification message sent by the terminal device of the user.

In some embodiments, the apparatus further comprises: a fourth sending unit, configured to send a vehicle location arrived notification message to the terminal device of the user, in response to reception of the vehicle location arrived notification message sent by the terminal device of the deliveryman.

In some embodiments, the apparatus further comprises: a reception unit, configured to receive location information of a current location of the deliveryman sent by the terminal device of the deliveryman; a matching unit, configured to match the location information of the current location of the deliveryman with location information of a location of the vehicle; and a fifth sending unit, configured to send a vehicle location arrived notification message to the terminal device of the user, in response to matching successfully.

In some embodiments, the apparatus further comprises: a sixth sending unit, configured to send a delivery video recording unlocking instruction for the article to a camera device of the deliveryman, in response to reception of the vehicle unlocked notification message sent by the terminal device of the user; and a seventh sending unit, configured to send a delivery video recording stop instruction for the article to the camera device of the deliveryman, in response to reception of the vehicle locked notification message sent by the terminal device of the user.

In some embodiments, the apparatus further comprises: a storage unit, configured to acquire a delivery video of the article from the camera device of the deliveryman, and store the delivery video of the article.

In some embodiments, the apparatus further comprises: an eighth sending unit, configured to send a delivery video viewing notification message of the article to the terminal device of the user; and a ninth sending unit, configured to send the delivery video of the article to the terminal device of the user, in response to reception of a delivery video viewing confirmation message of the article sent by the terminal device of the user.

In a third aspect, embodiments of the present disclosure provide an electronic device, the device electronic including: one or more processors; and a storage apparatus, storing one or more programs thereon, where the one or more programs, when executed by the one or more processors, cause the one or more processors to implement the method according to any embodiment of the first aspect.

In a fourth aspect, embodiments of the present disclosure provide a computer readable medium, storing a computer program thereon, where the program, when executed by a processor, implements the method according to any embodiment of the first aspect.

### BRIEF DESCRIPTION OF THE DRAWINGS

By reading the detailed description of non-limiting embodiments with reference to the following accompanying drawings, other features, objectives and advantages of the present disclosure will become more apparent.

FIG. 1 is an example system architecture in which embodiments of the present disclosure may be applied;

FIG. 2 is a flowchart of a method for delivering an article according to embodiments of the present disclosure;

FIG. 3A shows a schematic diagram of a vehicle location arrived notification button on a terminal of a deliveryman;

FIG. 3B shows a schematic diagram of a vehicle unlocked notification button on a terminal of a user;

FIG. 3C shows a schematic diagram of an article delivered notification button on a terminal of a deliveryman;

FIG. 3D shows a schematic diagram of a vehicle locked notification button on a terminal of a user;

FIG. 4 is a flowchart of the method for delivering an article according to embodiments of the present disclosure;

FIG. 5 is a schematic structural diagram of an apparatus for delivering an article according to embodiments of the present disclosure; and

FIG. 6 is a schematic structural diagram of a computer system suitable for implementing an electronic device according to embodiments of the present disclosure.

### DETAILED DESCRIPTION OF THE INVENTION

Embodiments of present disclosure will be described below in detail with reference to the accompanying drawings. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that some embodiments in the present disclosure and some features in the disclosure may be combined with each other on a non-conflict basis. Features of the present disclosure will be described below in detail with reference to the accompanying drawings and in combination with embodiments.

According to the method and apparatus for delivering an article provided by embodiments of the present disclosure, in the case that a deliveryman arrives near a user's vehicle, a vehicle unlocked notification message is sent to a terminal device of the deliveryman, in response to reception of the vehicle unlocked notification message sent by a terminal device of the user, so that the deliveryman delivers an article to the vehicle; an article delivered notification message is sent to the terminal device of the user, in response to reception of the article delivered notification message sent by the terminal device of the deliveryman, in order for the user to lock the vehicle and ensure the safety of the vehicle; and a vehicle locked notification message is sent to the terminal device of the deliveryman, in response to reception of the vehicle locked notification message sent by the terminal device of the user, so that the deliveryman ends this article delivery process. This embodiment implements the delivery of an article to a vehicle, improves the flexibility of article delivery, and reduces the loss rate of the article.

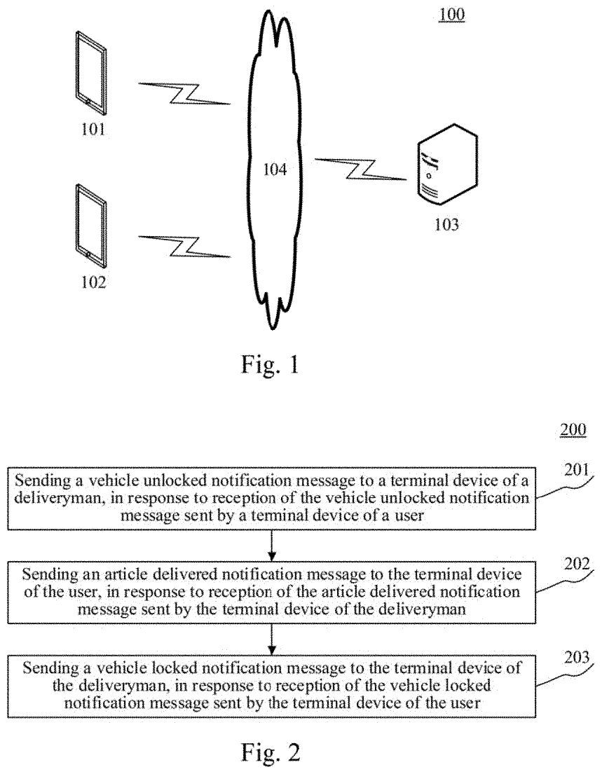

FIG. 1 shows an example system architecture 100 in which a method for delivering an article or an apparatus for delivering an article of embodiments of the present disclosure may be applied.

As shown in FIG. 1, the system architecture 100 may include terminal devices 101, 102, a server 103 and a network 104. The network 104 serves as a medium providing a communication link between the terminal devices 101, 102 and the server 103. The network 104 may include various types of connections, such as wired or wireless communication links, or optic fibers.

A user may interact with the server 103 through the network 104 using the terminal device 101, to receive or send messages. Various client applications may be installed on the terminal device 101, such as shopping applications, instant messaging applications, or vehicle remote control applications.

A deliveryman may use the terminal device 102 to interact with the server 103 through the network 104 to receive or send messages. Various client applications may be installed on the terminal device 102, such as shopping applications, instant messaging applications, or article delivery applications.

The terminal devices 101, 102 may be hardware or software. When the terminal devices 101, 102 are hardware, the terminal devices 101, 102 may be various electronic devices, including but not limited to smart phones, tablet computers, PDAs (personal digital assistants), laptop portable computers, desktop computers, or the like. When the terminal devices 101, 102 are software, the terminal devices 101, 102 may be installed in the electronic devices listed above. The terminal devices 101, 102 may be implemented as a plurality of pieces of software or software modules, or as a single piece of software or software module, which is not limited herein.

The server 103 may provide various services. For example, the server 103 may send a vehicle unlocked notification message to the terminal device 102, in response to reception of the vehicle unlocked notification message sent by the terminal device 101; send an article delivered notification message to the terminal device 101, in response to reception of the article delivered notification message sent by the terminal device 102; and send a vehicle locked notification message to the terminal device 102, in response to reception of the vehicle locked notification message sent by the terminal device 101.

It should be noted that the server 103 may be hardware or software. When the server 103 is hardware, the server 103 may be implemented as a distributed server cluster composed of a plurality of servers, or as a single server. When the server 103 is software, the server 103 may be implemented as a plurality of pieces of software or software modules (for example, for providing distributed servers), or as a single piece of software or software module, which is not limited herein.

It should be noted that the method for delivering an article provided by embodiments of the present disclosure is generally performed by the server 103, and accordingly, the apparatus for delivering an article is generally provided in the server 103.

It should be understood that the numbers of terminal devices, networks, and servers in FIG. 1 are merely illustrative. Depending on the implementation needs, there may be any number of terminal devices, networks, and servers.

With further reference to FIG. 2, a flow 200 of a method for delivering an article according to embodiments of the present disclosure is illustrated. The method for delivering an article includes the following steps.

Step 201, sending a vehicle unlocked notification message to a terminal device of a deliveryman, in response to reception of the vehicle unlocked notification message sent by a terminal device of a user.

In the present embodiment, when the user determines that the deliveryman has arrived near the user's vehicle, the user may first use the terminal device (such as the terminal device 101 shown in FIG. 1) of the user to remotely operate and unlock the vehicle, and then use the terminal device to send the vehicle unlocked notification message to a server (such as the server 103 shown in FIG. 1). Upon receiving the vehicle unlocked notification message, the server may send the vehicle unlocked notification message to the terminal device of the deliveryman (such as the terminal device 102 shown in FIG. 1).

Generally, when the deliveryman arrives near the user's vehicle according to an order address of the user, the user may be contacted so that the user may confirm that the deliveryman has arrived near the vehicle. Then, the user may open a vehicle remote control application installed on the terminal device of the user, and click a vehicle remote unlock button on the vehicle remote control application to control remote unlocking of the vehicle. Subsequently, the user may open a shopping application installed on the terminal device of the user, and click a vehicle unlocked notification button on the shopping application. Alternatively, the user may open an instant messaging application installed on the terminal device of the user, find a subscription account of the shopping application, click to enter a page corresponding to the subscription account of the shopping application, and click a vehicle unlocked notification button on the page corresponding to the subscription account of the shopping application. When the user clicks the vehicle unlocked notification button, the vehicle unlocked notification message may be sent to the server. The server may send the received vehicle unlocked notification message to the terminal device of the deliveryman. Upon viewing the vehicle unlocked notification message, the deliveryman may confirm that the vehicle is unlocked. Then, the deliveryman may open the door of the vehicle and deliver the article to the user's vehicle.

In practice, upon arriving near the user's vehicle, the deliveryman may inform the user that he/she has arrived near the vehicle in various methods.

In some alternative implementations of the present embodiment, the deliveryman may call to inform the user that he/she has arrived near the vehicle.

In some alternative implementations of the present embodiment, the deliveryman may use the terminal device of the deliveryman to send a vehicle location arrived notification message to the server. Upon receiving the vehicle location arrived notification message, the server may send the vehicle location arrived notification message to the terminal device of the user. Generally, the deliveryman may open a logistics delivery application installed on the terminal device of deliveryman, and click a vehicle location arrived notification button on the logistics delivery application. Then, the terminal device of the deliveryman may send the vehicle location arrived notification message to the server. The server may send the received vehicle location arrived notification message to the terminal device of the user. Upon viewing the vehicle location arrived notification message, the user may consider that the deliveryman has arrived near the user's vehicle.

In some alternative implementations of the present embodiment, the terminal device of the deliveryman has a positioning function. In this regard, the terminal device of the deliveryman may send location information of a current location of the deliveryman to the server in real time. Upon receiving the location information of the current location of the deliveryman, the server may match the location information of the current location of the deliveryman with location information of a location of the vehicle. If the matching is successful, the server may send the vehicle location arrived notification message to the terminal device of the user. In practice, if a distance between the current location of the deliveryman and the location of the vehicle is not greater than a preset distance (for example, 3 meters), it may be considered that the location information of the current location of the deliveryman matches the location information of the location of the vehicle successfully.

Step 202, sending an article delivered notification message to the terminal device of the user, in response to reception of the article delivered notification message sent by the terminal device of the deliveryman.

In the present embodiment, after the article is delivered to the user's vehicle, the deliveryman may use the terminal device of the deliveryman to send the article delivered notification message to the server. Upon receiving the article delivered notification message, the server may send the article delivered notification message to the terminal device of the user.

Generally, after delivering the article to the user's vehicle and closing the door, the deliveryman may click an article delivered notification button on an article delivery application. Then, the terminal device of the deliveryman may send the article delivered notification message to the server. The server may send the received article delivered notification message to the terminal device of the user. Upon viewing the article delivered notification message, the user may consider that the article has been delivered to the vehicle. Then, the user may click a vehicle remote lock button on the vehicle remote control application to control remote lock of the vehicle.

Step 203, sending a vehicle locked notification message to the terminal device of the deliveryman, in response to reception of the vehicle locked notification message sent by the terminal device of the user.

In the present embodiment, after the vehicle is remotely locked, the user may use the terminal device of the user to send the vehicle locked notification message to the server. Upon receiving the vehicle locked notification message, the server may send the vehicle locked notification message to the terminal device of the deliveryman.

Generally, after the vehicle is locked remotely, the user may click a vehicle locked notification button on the shopping application. Alternatively, the user may click the vehicle locked notification message on the page corresponding to the subscription account of the shopping application. Then, the terminal device of the user may send the vehicle locked notification message to the server. The server may send the received vehicle locked notification message to the terminal device of the deliveryman. Upon viewing the vehicle locked notification message, the deliveryman may consider that this article delivery process is over.

In practice, if a receiving method for an order of the user includes vehicle receiving, the method for delivering an article provided in embodiments of the present disclosure may be performed. Under normal circumstances, the vehicle unlocked notification button on the shopping application or instant messaging application is not clickable. Upon receiving the vehicle location arrived notification message, the vehicle unlocked notification button on the shopping application becomes clickable.

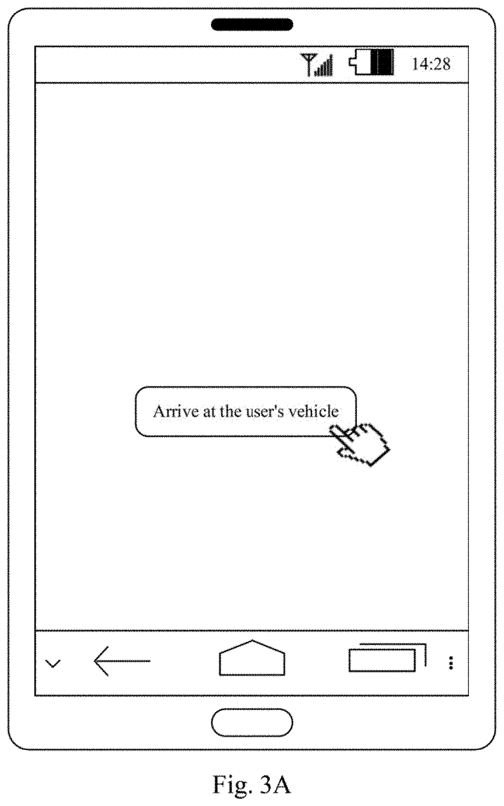

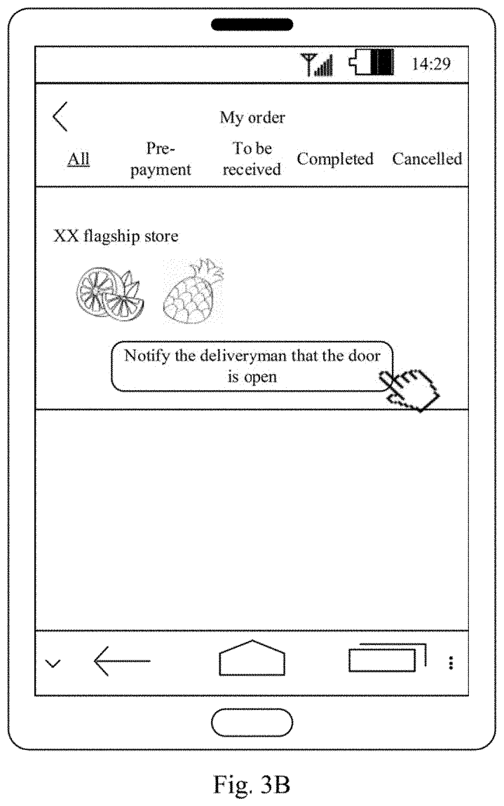

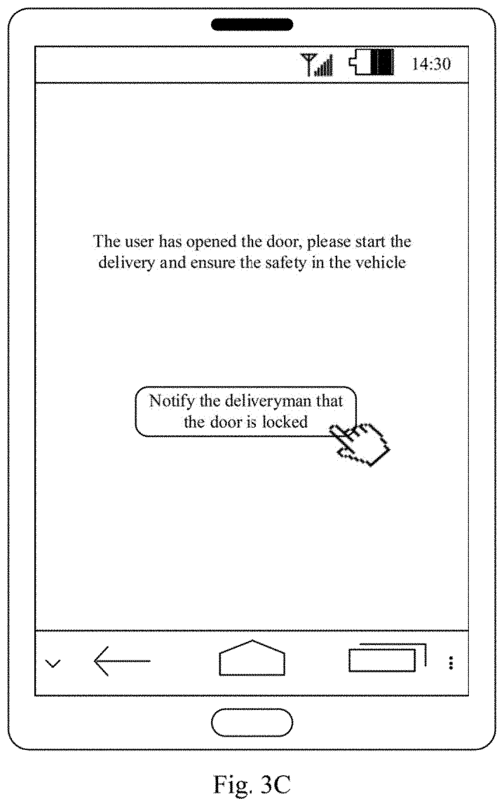

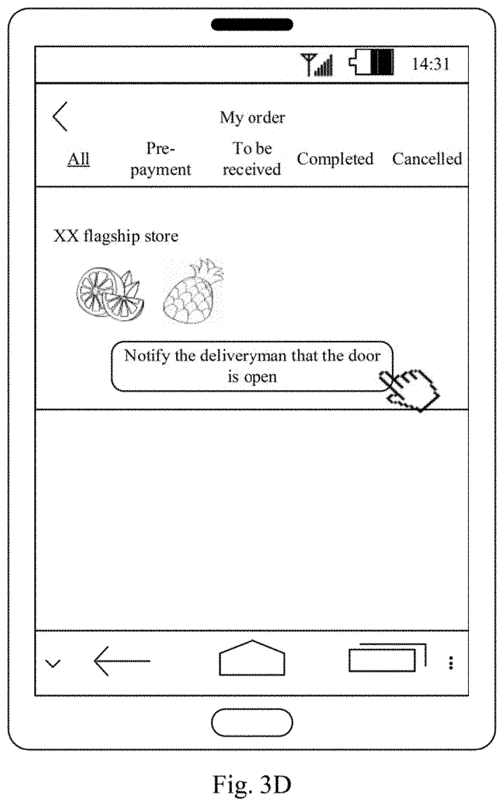

Embodiments of the present disclosure further provide an application scenario of the method for delivering an article. In this application scenario, if the receiving method for an order of the user is vehicle receiving, a deliveryman may find the user's vehicle according to an order address of the user. In this regard, the deliveryman may open a logistics delivery application installed on the terminal device of the deliveryman, and click a vehicle location arrived notification button on the logistics delivery application, so as to send a vehicle location arrived notification message to a terminal device of the user through a server. FIG. 3A shows a schematic diagram of a vehicle location arrived notification button on a terminal of a deliveryman. The vehicle location arrived notification button may be marked with the text message “Arrive at the user's vehicle”. After opening a shopping application installed on the terminal device of the user and viewing the vehicle location arrived notification message, the user may open a vehicle remote control application installed on the terminal device of the user and click a vehicle remote unlock button on the vehicle remote control application to control remote unlocking of the vehicle. Subsequently, the user may click a vehicle unlocked notification button on the shopping application to send a vehicle unlocked notification message to the terminal device of the deliveryman through the server. FIG. 3B shows a schematic diagram of a vehicle unlocked notification button on a terminal of a user. The vehicle unlocked notification button may be marked with the text message “Notify the deliveryman that the door is open”. After viewing the vehicle unlocked notification message, the deliveryman may open the door of the vehicle, deliver the article to the user's vehicle, and close the door. Subsequently, the deliveryman clicks on an article delivered notification button on an article delivery application, so as to send an article delivered notification message to the terminal device of the user through the server. FIG. 3C shows a schematic diagram of an article delivered notification button on a terminal of a deliveryman. The article delivered notification button may be marked with the text message “Notify the user to lock the vehicle”. The user may click a vehicle remote lock button on the vehicle remote control application to control remote lock of the vehicle. Subsequently, the user may click a vehicle locked notification button on the shopping application to send a vehicle locked notification message to the terminal device of the deliveryman through the server. FIG. 3D shows a schematic diagram of a vehicle locked notification button on a terminal of a user. The vehicle locked notification button may be marked with the text message “Notify the deliveryman that the door is locked”. After viewing the vehicle locked notification message, the deliveryman may end this article delivery process.

According to the method for delivering an article provided by embodiments of the present disclosure, in the case that a deliveryman arrives near a user's vehicle, a vehicle unlocked notification message is sent to a terminal device of the deliveryman, in response to reception of the vehicle unlocked notification message sent by a terminal device of the user, so that the deliveryman delivers an article to the vehicle; an article delivered notification message is sent to the terminal device of the user, in response to reception of the article delivered notification message sent by the terminal device of the deliveryman, in order for the user to lock the vehicle and ensure the safety of the vehicle; and a vehicle locked notification message is sent to the terminal device of the deliveryman, in response to reception of the vehicle locked notification message sent by the terminal device of the user, so that the deliveryman ends this article delivery process. This embodiment implements the delivery of an article to a vehicle, improves the flexibility of article delivery, and reduces the loss rate of the article.

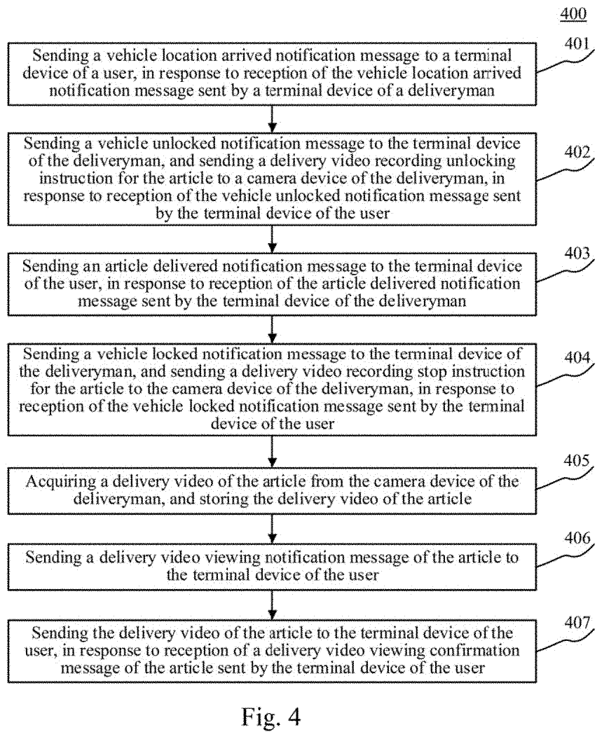

With further reference to FIG. 4, a flow 400 of the method for delivering an article according to embodiments of the present disclosure is illustrated. The method for delivering an article includes the following steps.

Step 401, sending a vehicle location arrived notification message to a terminal device of a user, in response to reception of the vehicle location arrived notification message sent by a terminal device of a deliveryman.

In the present embodiment, upon arriving near the user's vehicle, the deliveryman may use the terminal device (such as the terminal device 101 shown in FIG. 1) of the deliveryman to send the vehicle location arrived notification message to a server (such as the server 103 shown in FIG. 1). Upon receiving the vehicle location arrived notification message, the server may send the vehicle location arrived notification message to the terminal device of the user (such as the terminal device 102 shown in FIG. 1).

Generally, upon arriving near the user's vehicle according to an order address of the user, the deliveryman may open a logistics delivery application installed on the terminal device of the deliveryman, and click a vehicle location arrived notification button on the logistics delivery application. Then, the terminal device of the deliveryman may send the vehicle location arrived notification message to the server. The server may send the received vehicle location arrived notification message to the terminal device of the user. Upon viewing the vehicle location arrived notification message, the user may consider that the deliveryman has arrived near the user's vehicle.

Step 402, sending a vehicle unlocked notification message to the terminal device of the deliveryman, and sending a delivery video recording unlocking instruction for the article to a camera device of the deliveryman, in response to reception of the vehicle unlocked notification message sent by the terminal device of the user.

In the present embodiment, when the user determines that the deliveryman has arrived near the user's vehicle, the user may first use the terminal device of the user to remotely operate and unlock the vehicle, and then use the terminal device to send the vehicle unlocked notification message to the server. Upon receiving the vehicle unlocked notification message, the server may send the vehicle unlocked notification message to the terminal device of the deliveryman, and at the same time send the delivery video recording unlocking instruction for the article to the camera device of the deliveryman.

Generally, the deliveryman wears a camera device having its lens assembly facing the front. Upon receiving the vehicle unlocked notification message, the server may send the delivery video recording unlocking instruction for the article to the camera device of the deliveryman. Upon receiving the delivery video recording unlocking instruction, the camera device may turn on a recording function to record a delivery video of the deliveryman delivering the article.

Step 403, sending an article delivered notification message to the terminal device of the user, in response to reception of the article delivered notification message sent by the terminal device of the deliveryman.

In the present embodiment, the specific operation of step 403 has been described in detail in step 202 in the embodiment shown in FIG. 2, and detailed description thereof will be omitted.

Step 404, sending a vehicle locked notification message to the terminal device of the deliveryman, and sending a delivery video recording stop instruction for the article to the camera device of the deliveryman, in response to reception of the vehicle locked notification message sent by the terminal device of the user.

In the present embodiment, after the vehicle is remotely locked, the user may use the terminal device of the user to send the vehicle locked notification message to the server. Upon receiving the vehicle locked notification message, the server may send the vehicle locked notification message to the terminal device of the deliveryman, and at the same time send the delivery video recording stop instruction for the article to the camera device of the deliveryman.

Generally, upon receiving the vehicle locked notification message, the server may send the delivery video recording stop instruction for the article to the camera device of the deliveryman. Upon receiving the delivery video recording stop instruction, the camera device may turn off the recording function. In this regard, the camera device has recorded an entire process of article delivery into a delivery video.

Step 405, acquiring a delivery video of the article from the camera device of the deliveryman, and storing the delivery video of the article.

In the present embodiment, after the recording of the delivery video of the article is completed, the camera device may upload the delivery video of the article to the server. The server may store the delivery video of the article acquired from the camera device of the deliveryman.

Step 406, sending a delivery video viewing notification message of the article to the terminal device of the user.

In the present embodiment, after the delivery video of the article is stored in the server, the server may send the delivery video viewing notification message of the article to the terminal device of the user.

Step 407, sending the delivery video of the article to the terminal device of the user, in response to reception of a delivery video viewing confirmation message of the article sent by the terminal device of the user.

In the present embodiment, if the user wants to view the delivery video of the article, the user may use the terminal device of the user to send the delivery video viewing confirmation message of the article to the server. After receiving the delivery video viewing confirmation message of the article, the server may send the delivery video of the article to the terminal device of the user.

Generally, if the user wants to view the delivery video of the article, the user may click a delivery video viewing confirmation button on a shopping application or a page corresponding to the subscription account of the shopping application. Then, the terminal device of the user may send the delivery video viewing confirmation message to the server. Upon receiving the delivery video viewing confirmation message, the server may send the delivery video of the article to the terminal device of the user. After receiving the delivery video of the article, if the user clicks a play button on the delivery video of the article, the delivery video of the article may be played on the terminal device of the user.

In practice, the deliveryman may also manually turn on a camera function of the camera device after notifying the user that he/she has arrived near the vehicle, and manually turn off the camera function of the camera device after viewing the vehicle locked notification message sent by the user, and manually upload the captured delivery video of the article to the server.

It can be seen from FIG. 4 that, compared with the embodiment corresponding to FIG. 2, the flow 400 of the video communication method in the present embodiment adds a step of recording the delivery video of the article. Thus, the solution described in the present embodiment records the entire process of the deliveryman opening the door to deliver the article to closing the door into a video for the user to view, thereby improving the safety of the article delivery process.

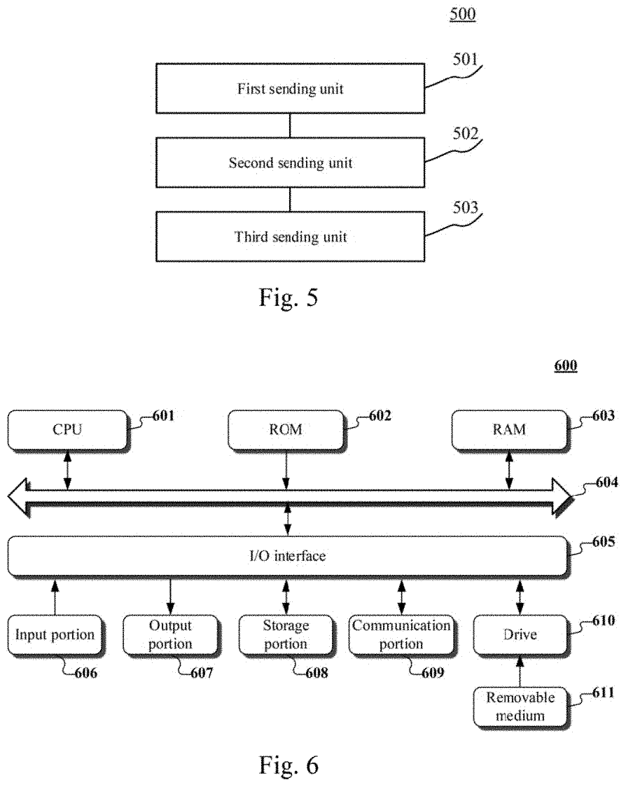

With further reference to FIG. 5, as an implementation of the method shown in the above figures, embodiments of the present disclosure provide an apparatus for delivering an article, and the apparatus embodiment corresponds to the method embodiment as shown in FIG. 2. The apparatus may be applied to various electronic devices.

As shown in FIG. 5, an apparatus 500 for delivering an article of the present embodiment may include: a first sending unit 501, a second sending unit 502 and a third sending unit 503. The first sending unit 501 is configured to send a vehicle unlocked notification message to a terminal device of a deliveryman, in response to reception of the vehicle unlocked notification message sent by a terminal device of a user. The second sending unit 502 is configured to send an article delivered notification message to the terminal device of the user, in response to reception of the article delivered notification message sent by the terminal device of the deliveryman, the article being delivered to the vehicle. The third sending unit 503 is configured to send a vehicle locked notification message to the terminal device of the deliveryman, in response to reception of the vehicle locked notification message sent by the terminal device of the user.

In the present embodiment, in the apparatus 500 for delivering an article: for the specific processing and the technical effects of the first sending unit 501, the second sending unit 502, and the third sending unit 503, reference may be made to the relevant descriptions of step 201, step 202, and step 203 in the corresponding embodiment of FIG. 2, respectively, and detailed description thereof will be omitted.

In some alternative implementations of the present embodiment, the apparatus 500 for delivering an article may further include: a fourth sending unit (not shown in the figure), configured to send a vehicle location arrived notification message to the terminal device of the user, in response to reception of the vehicle location arrived notification message sent by the terminal device of the deliveryman.

In some alternative implementations of the present embodiment, the apparatus 500 for delivering an article may further include: a reception unit (not shown in the figure), configured to receive location information of a current location of the deliveryman sent by the terminal device of the deliveryman; a matching unit (not shown in the figure), configured to match the location information of the current location of the deliveryman with location information of a location of the vehicle; and a fifth sending unit (not shown in the figure), configured to send the vehicle location arrived notification message to the terminal device of the user, in response to matching successfully.

In some alternative implementations of the present embodiment, the apparatus 500 for delivering an article may further include: a sixth sending unit (not shown in the figure), configured to send a delivery video recording unlocking instruction for the article to a camera device of the deliveryman, in response to reception of the vehicle unlocked notification message sent by the terminal device of the user; and a seventh sending unit (not shown in the figure), configured to send a delivery video recording stop instruction for the article to the camera device of the deliveryman, in response to reception of the vehicle locked notification message sent by the terminal device of the user.

In some alternative implementations of the present embodiment, the apparatus 500 for delivering an article may further include: a storage unit (not shown in the figure), configured to acquire a delivery video of the article from the camera device of the deliveryman, and store the delivery video of the article.

In some alternative implementations of the present embodiment, the apparatus 500 for delivering an article may further include: an eighth sending unit (not shown in the figure), configured to send a delivery video viewing notification message of the article to the terminal device of the user; and a ninth sending unit (not shown in the figure, configured to send the delivery video of the article to the terminal device of the user, in response to reception of a delivery video viewing confirmation message of the article sent by the terminal device of the user.

With further reference to FIG. 6, FIG. 6 shows a schematic structural diagram of a computer system 600 suitable for implementing an electronic device (such as the server 103 shown in FIG. 1) according to embodiments of the present disclosure. The electronic device shown in FIG. 6 is only an example, and should not bring any limitation to the functions and scope of use of embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse, etc.; an output portion 607 including such as a cathode ray tube (CRT), a liquid crystal display device (LCD), a speaker, etc.; the storage portion 608 including a hard disk and the like; and a communication portion 609 including a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to embodiments of the present disclosure, the process described above with reference to the flow chart may be implemented in a computer software program. For example, embodiments of the present disclosure include a computer program product, which includes a computer program that is tangibly embedded in a computer-readable medium. The computer program includes program codes for performing the method as illustrated in the flow chart. In such an embodiment, the computer program may be downloaded and installed from a network via the communication portion 609, and/or may be installed from the removable medium 611. The computer program, when executed by the central processing unit (CPU) 601, implements the above mentioned functionalities as defined by the method of the present disclosure. It should be noted that the computer readable medium according to some embodiments of the present disclosure may be a computer readable signal medium or a computer readable medium or any combination of the above two. An example of the computer readable medium may include, but is not limited to: electric, magnetic, optical, electromagnetic, infrared, or semiconductor systems, apparatuses, elements, or a combination of any of the above. A more specific example of the computer readable medium may include, but is not limited to: electrical connection with one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. In some embodiments of the present disclosure, the computer readable medium may be any tangible medium containing or storing programs, which may be used by, or used in combination with, a command execution system, apparatus or element. In some embodiments of the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

A computer program code for executing operations in some embodiments of the present disclosure may be compiled using one or more programming languages or combinations thereof. The programming languages include object-oriented programming languages, such as Java, Smalltalk or C++, and also include existing procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In a circumstance involving a remote computer, the remote computer may be connected to a user's computer through any network, including local area network (LAN) or wide area network (WAN), or be connected to an external computer (for example, connected through the Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logical functions. It should be further noted that, in some alternative implementations, the functions denoted by the blocks may also occur in a sequence different from the sequences shown in the figures. For example, any two blocks presented in succession may be executed substantially in parallel, or they may sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in embodiments of the present disclosure may be implemented by means of software or hardware. The described units may also be provided in a processor, for example, may be described as: a processor including a first sending unit, a second sending unit and a third sending unit. Here, the names of these units do not in some cases constitute limitations to such units themselves. For example, the first sending unit may also be described as “a unit configured to send a vehicle unlocked notification message to a terminal device of a deliveryman, in response to reception of the vehicle unlocked notification message sent by a terminal device of a user.

In another aspect, the present disclosure further provides a computer readable medium. The computer readable medium may be included in the electronic device in the above described embodiments, or a stand-alone computer readable medium not assembled into the electronic device. The computer readable medium carries one or more programs, the one or more programs, when executed by the electronic device, cause the electronic device to: send a vehicle unlocked notification message to a terminal device of a deliveryman, in response to reception of the vehicle unlocked notification message sent by a terminal device of a user; send an article delivered notification message to the terminal device of the user, in response to reception of the article delivered notification message sent by the terminal device of the deliveryman, the article being delivered to the vehicle; and send a vehicle locked notification message to the terminal device of the deliveryman, in response to reception of the vehicle locked notification message sent by the terminal device of the user.

The above description only provides an explanation of embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

What is claimed is:

1. A method for delivering an article, the method comprising:
sending a vehicle unlocked notification message to a terminal device of a deliveryman, in response to reception of the vehicle unlocked notification message sent by a terminal device of a user;
sending an article delivered notification message to the terminal device of the user, in response to reception of the article delivered notification message sent by the terminal device of the deliveryman, the article being delivered to the vehicle; and
sending a vehicle locked notification message to the terminal device of the deliveryman, in response to reception of the vehicle locked notification message sent by the terminal device of the user.

2. The method according to claim 1, wherein, before the sending the vehicle unlocked notification message to the terminal device of the deliveryman, in response to reception of the vehicle unlocked notification message sent by the terminal device of the user, the method further comprises:
sending a vehicle location arrived notification message to the terminal device of the user, in response to reception of the vehicle location arrived notification message sent by the terminal device of the deliveryman.

3. The method according to claim 1, wherein, before the sending the vehicle unlocked notification message to the terminal device of the deliveryman, in response to reception of the vehicle unlocked notification message sent by the terminal device of the user, the method further comprises:
receiving location information of a current location of the deliveryman sent by the terminal device of the deliveryman;
matching the location information of the current location of the deliveryman with location information of a location of the vehicle; and
sending a vehicle location arrived notification message to the terminal device of the user, in response to matching successfully.

4. The method according to claim 1, wherein the method further comprises:
sending a delivery video recording unlocking instruction for the article to a camera device of the deliveryman, in response to reception of the vehicle unlocked notification message sent by the terminal device of the user; and
sending a delivery video recording stop instruction for the article to the camera device of the deliveryman, in response to reception of the vehicle locked notification message sent by the terminal device of the user.

5. The method according to claim 4, wherein, after the sending the delivery video recording stop instruction for the article to the camera device of the deliveryman, the method further comprises:
acquiring a delivery video of the article from the camera device of the deliveryman, and storing the delivery video of the article.

6. The method according to claim 5, wherein, after the acquiring the delivery video of the article from the camera device of the deliveryman, and storing the delivery video of the article, the method further comprises:
sending a delivery video viewing notification message of the article to the terminal device of the user; and
sending the delivery video of the article to the terminal device of the user, in response to reception of a delivery video viewing confirmation message of the article sent by the terminal device of the user.

7. The method according to claim 3, wherein the method further comprises:
determining that the location information of the current location of the deliveryman matches the location information of the location of the vehicle successfully, in response to determining that a distance between the current location of the deliveryman and the location of the vehicle is not greater than a preset distance.

8. An apparatus for delivering an article, the apparatus comprising:
one or more processors; and
a storage apparatus, storing one or more programs thereon,
wherein the one or more programs, when executed by the one or more processors, cause the one or more processors to perform operations, the operations comprising:
sending a vehicle unlocked notification message to a terminal device of a deliveryman, in response to reception of the vehicle unlocked notification message sent by a terminal device of a user;
sending an article delivered notification message to the terminal device of the user, in response to reception of the article delivered notification message sent by the terminal device of the deliveryman, the article being delivered to the vehicle; and
sending a vehicle locked notification message to the terminal device of the deliveryman, in response to reception of the vehicle locked notification message sent by the terminal device of the user.

9. The apparatus according to claim 8, wherein, before the sending the vehicle unlocked notification message to the terminal device of the deliveryman, in response to reception of the vehicle unlocked notification message sent by the terminal device of the user, the operations further comprise:
sending a vehicle location arrived notification message to the terminal device of the user, in response to reception of the vehicle location arrived notification message sent by the terminal device of the deliveryman.

10. The apparatus according to claim 8, wherein, before the sending the vehicle unlocked notification message to the terminal device of the deliveryman, in response to reception of the vehicle unlocked notification message sent by the terminal device of the user, the operations further comprise:
receiving location information of a current location of the deliveryman sent by the terminal device of the deliveryman;
matching the location information of the current location of the deliveryman with location information of a location of the vehicle; and
sending a vehicle location arrived notification message to the terminal device of the user, in response to matching successfully.

11. The apparatus according to claim 8, wherein the operations further comprise:
sending a delivery video recording unlocking instruction for the article to a camera device of the deliveryman, in response to reception of the vehicle unlocked notification message sent by the terminal device of the user; and
sending a delivery video recording stop instruction for the article to the camera device of the deliveryman, in response to reception of the vehicle locked notification message sent by the terminal device of the user.

12. The apparatus according to claim 11, wherein, after the sending the delivery video recording stop instruction for the article to the camera device of the deliveryman, the operations further comprise:
acquiring a delivery video of the article from the camera device of the deliveryman, and store the delivery video of the article.

13. The apparatus according to claim 12, wherein, after the acquiring the delivery video of the article from the camera device of the deliveryman, and storing the delivery video of the article, the operations further comprise:
sending a delivery video viewing notification message of the article to the terminal device of the user; and
sending the delivery video of the article to the terminal device of the user, in response to reception of a delivery video viewing confirmation message of the article sent by the terminal device of the user.

14. The apparatus according to claim 10, wherein the operations further comprise:
determining that the location information of the current location of the deliveryman matches the location information of the location of the vehicle successfully, in response to determining that a distance between the current location of the deliveryman and the location of the vehicle is not greater than a preset distance.

15. A non-transitory computer readable medium, storing a computer program thereon, wherein the program, when executed by a processor, causes the processor to perform operations, the operations comprising:
sending a vehicle unlocked notification message to a terminal device of a deliveryman, in response to reception of the vehicle unlocked notification message sent by a terminal device of a user;
sending an article delivered notification message to the terminal device of the user, in response to reception of the article delivered notification message sent by the terminal device of the deliveryman, the article being delivered to the vehicle; and
sending a vehicle locked notification message to the terminal device of the deliveryman, in response to reception of the vehicle locked notification message sent by the terminal device of the user.

16. The non-transitory computer readable medium according to claim 15, wherein, before the sending the vehicle unlocked notification message to the terminal device of the deliveryman, in response to reception of the vehicle unlocked notification message sent by the terminal device of the user, the operations further comprise:
sending a vehicle location arrived notification message to the terminal device of the user, in response to reception of the vehicle location arrived notification message sent by the terminal device of the deliveryman.

17. The non-transitory computer readable medium according to claim 15, wherein, before the sending the vehicle unlocked notification message to the terminal device of the deliveryman, in response to reception of the vehicle unlocked notification message sent by the terminal device of the user, the operations further comprise:
receiving location information of a current location of the deliveryman sent by the terminal device of the deliveryman;
matching the location information of the current location of the deliveryman with location information of a location of the vehicle; and
sending a vehicle location arrived notification message to the terminal device of the user, in response to matching successfully.

18. The non-transitory computer readable medium according to claim 15, wherein the operations further comprise:
sending a delivery video recording unlocking instruction for the article to a camera device of the deliveryman, in response to reception of the vehicle unlocked notification message sent by the terminal device of the user; and
sending a delivery video recording stop instruction for the article to the camera device of the deliveryman, in response to reception of the vehicle locked notification message sent by the terminal device of the user.

19. The non-transitory computer readable medium according to claim 18, wherein, after the sending the delivery video recording stop instruction for the article to the camera device of the deliveryman, the operations further comprise:
acquiring a delivery video of the article from the camera device of the deliveryman, and store the delivery video of the article.

20. The non-transitory computer readable medium according to claim 19, wherein, after the acquiring the delivery video of the article from the camera device of the deliveryman, and storing the delivery video of the article, the operations further comprise:
sending a delivery video viewing notification message of the article to the terminal device of the user; and
sending the delivery video of the article to the terminal device of the user, in response to reception of a delivery video viewing confirmation message of the article sent by the terminal device of the user.
